(19) United States
(12) Patent Application Publication
(10) Pub. No.: US 2017/0043863 A1
(43) Pub. Date: Feb. 16, 2017

(54) MICROELECTRONIC MODULE, MODULE ARRAY, AND METHOD FOR INFLUENCING A FLOW

(71) Applicant: AIRBUS DEFENCE AND SPACE GMBH, Taufkirchen (DE)

(72) Inventors: Ralf CASPARI, Kosching (DE); Robert WEICHWALD, Siegenburg (DE); Emanuel ERMANN, Oberstimm (DE); Karin BAUER, Oberhaching (DE)

(21) Appl. No.: 15/233,495

(22) Filed: Aug. 10, 2016

(30) Foreign Application Priority Data
Aug. 12, 2015 (DE) 10 2015 010 233.8

(51) Int. Cl. B64C 23/00; F15D 1/10

(52) U.S. Cl. CPC B64C 23/005; F15D 1/10; B64D 2211/00

(57) ABSTRACT

A microelectronic module for influencing a flow of a fluid is provided. The module comprises at least one voltage converter for converting a provided first voltage into a higher, lower, or identical second voltage. The module also comprises at least one active flow-influencing element for influencing the direction and/or the speed of a fluid which is flowing around and/or over the flow-influencing element. At least the voltage converter and the active flow-influencing element are disposed on a thin-film, planar substrate. The influencing of the direction and/or the speed of the fluid is dependent on a hydrodynamic acceleration as a function of the second voltage provided by the voltage converter at the flow-influencing element.

### CROSS-REFERENCE TO RELATED APPLICATION

This application claims priority to German Patent Application DE 10 2015 010 233.8 filed Aug. 12, 2015, the entire disclosure of which is incorporated by reference herein.

### TECHNICAL FIELD

Different embodiments relate, in general, to a microelectronic module for influencing a flow of a fluid, and to a module array and a method for influencing a flow of a fluid.

### BACKGROUND

The development of modern vehicles, for example, modern aircraft, is continuously focused on lowering the costs for ongoing operation. Kerosene consumption, for example, is a major cost factor in this regard. In order to reduce the kerosene consumption in an aircraft, for example, attempts are being made, inter alia, to improve the aerodynamics of the aircraft. This is occurring, for example, in the region of the wings by so-called winglets or Sharklets, or by a particular structuring of parts of leading edges of wings in order to reduce the flow resistance of the aircraft. Improvements of this type are frequently based on a passive effect which, in the case of so-called riblets, for example, is based on reducing the frictional resistance on surfaces having turbulent air flow over them. In this case, riblets take full advantage of a particular surface geometry, with the aid of which turbulent flows on a surface having turbulent air flows over them and, therefore, friction losses, can be reduced. These improvements have the disadvantage, however, that they frequently function only passively and are not variable in terms of direction.

Proceeding therefrom, a problem addressed by the disclosure herein is that of providing a device which avoids the aforementioned disadvantages.

This problem is solved by a device having the features disclosed herein. Exemplary embodiments are described herein. It is pointed out that the features of the exemplary embodiments of the devices also apply for embodiments of the method and the use of the device, and vice versa.

### SUMMARY

A microelectronic module for influencing a flow of a fluid is provided. The module comprises at least one voltage converter for converting a provided first voltage into a higher, lower, or identical second voltage. The module also comprises at least one active flow-influencing element for influencing the direction and/or the speed of a fluid which is flowing around and/or over the active flow-influencing element. At least the voltage converter and the active flow-influencing element are disposed on a thin-film, planar substrate. The influencing of the direction and/or the speed of the fluid is dependent on a hydrodynamic acceleration as a function of the second voltage provided by the voltage converter at the active flow-influencing element.

The disclosure herein is based on the concept of influencing the direction and/or the speed of a fluid flowing around or over a surface by a hydrodynamic acceleration which is generated by a voltage applied at an active flow-influencing element. In this case, the direction and/or speed of the fluid in the region of the active flow-influencing element can be changed, i.e., the direction can be changed and/or the speed can be reduced or increased. By integrating the components necessary for this on a film in a very small scale, the module can be easily mounted, for example, on a surface of a vehicle in order to influence the direction and/or speed of the fluid flowing past on the surface, in order to improve the flow of the fluid around or over the surface, i.e., for example, in order to reduce a flow resistance or, if desired, to increase it. As a result, for example, the kerosene consumption of an aircraft which comprises, for example, a plurality of these modules on a leading edge of a wing, for example, can be reduced.

The term “active flow-influencing element” can be considered to be any electrical element which is capable of actively generating a hydrodynamic acceleration with the aid of an applied voltage.

The term “voltage converter” can be considered to be any electrical element which is capable of converting an input voltage into a higher, lower, or identical output voltage. For the case in which the input voltage corresponds to the output voltage, the electrical element can also consist of or comprise only one electrical connecting element.

According to one preferred embodiment, the microelectronic module is a MEMS (micro-electro-mechanical system) module, i.e., is designed as a MEMS. Alternatively, the module can also be designed as a nanoelectromechanical system.

According to one preferred embodiment, the voltage converter of the microelectronic module comprises a piezoelectric transformer. This has the advantage that piezoelectric transformers can be produced in a very small scale.

According to one preferred embodiment, the fluid is air, oil, or water. The direction and/or the speed of air, oil, or water flowing around or past a surface can be influenced by the flow-influencing element. This has the advantage that, for example, a flow resistance on a surface can be reduced or, if desired, increased.

According to one preferred embodiment, the active flow-influencing element comprises an asymmetrically designed capacitor. In the case of an asymmetrically designed capacitor, an ionic current can be generated in the region of the capacitor by applying a voltage. The ionic current is dependent on the voltage which is applied at the capacitor. Preferably, a voltage which is slightly below the breakdown voltage of the capacitor is applied at the capacitor. Simultaneously, a fluid in the direct environment of the ionic current, i.e., of the capacitor, can be influenced by the ionic current, i.e., can be changed in a certain direction by the ionic current. This has the advantage that the direction and/or speed of a fluid in the environment of the capacitor can be actively influenced by the ionic current.

The electrodes of the capacitor can have virtually any shape, arrangement, or number, or can consist of or comprise virtually any type of material which is suitable for generating an ionic current which is suitable for influencing the direction and/or speed of a fluid flowing around or over the electrodes.

According to one preferred embodiment, the provided first voltage for the voltage converter is provided, at least partially, via an external voltage source. For example, the first voltage is provided by a voltage source outside of the module. For example, the voltage source can be an energy-generating element which, like the module, is mounted on a surface. Alternatively, the energy-generating element can also be, for example, a drive device of a vehicle, on the surface of which the module is mounted. This has the advantage that the geometric dimensions of the module can be kept very small.

According to one preferred embodiment, the substrate also comprises an energy-generating element for generating at least a portion of the first voltage to be provided. For example, one or more energy-generating elements of the same type or different types, which provide the first voltage for the module, can be disposed on the substrate. In addition to the at least one energy-generating element on the substrate, the module can also comprise a connection for providing at least a portion of the first voltage by an external voltage source. This has the advantage that the module is either partially or entirely self-sufficient with respect to an external voltage source. This has the further advantage that the module can be flexibly mounted at or on any type of surface.

According to one preferred embodiment, the substrate also comprises an energy-generating element for generating at least a portion of the first voltage to be provided, wherein the energy-generating element has a solar cell arrangement. Alternatively, the energy-generating element can also have any other type of suitable device for generating electrical energy. This has the advantage that the module is preferably independent of an external voltage source and can be operated self-sufficiently. This has the further advantage that the module can be flexibly mounted on any type of surface. When the module is mounted on a surface of an aircraft, a solar cell arrangement is suitable for generating electrical energy, since an aircraft, in the flight phase, preferably flies above the cloud layer and is therefore not subjected to being shaded from the sun due to clouds.

According to one preferred embodiment, the thin-film, planar substrate is a flexible and/or multidimensionally deformable film or lattice. For example, the lattice can have a flexible and/or multidimensionally deformable lattice structure. Alternatively, the thin-film, planar substrate can also consist of or comprise a comparable material which is suitable for enabling the components of the module to be mounted on, in, or at the substrate, and which is as thin as possible and is sufficiently stable. For example, the substrate can also have a fabric or a lattice structure or a composite material. This has the advantage that the geometric dimensions of the module can be kept small, wherein a sufficient stability is given, in order to permanently or reversibly mount the module, for example, on a surface, for example, adhesively.

According to one preferred embodiment, the module comprises a plurality of active flow-influencing elements. The plurality of active flow-influencing elements has a different orientation and/or an identical orientation.

According to a further preferred embodiment, the module comprises a plurality of active flow-influencing elements and/or at least one passive flow-influencing element. The plurality of active and/or passive flow-influencing elements has a different orientation and/or an identical orientation.

More precisely, the direction of the influence, i.e., the orientation of the active flow-influencing elements or of the active and/or passive flow-influencing elements, on the fluid in the region of the flow-influencing elements is different and/or identical. This has the advantage that the direction and/or speed of a fluid in the region of the active flow-influencing elements can be influenced in virtually any way by specifically activating and/or deactivating single or multiple flow-influencing elements.

A passive flow-influencing element is considered to be a passive structure which is suitable for supporting or amplifying the generated effect. Passive structures can be 3D, microtechnical, passive and/or resonant structures which can locally influence, preferably swirl or locally deflect, the generated flow. According to one embodiment, the passive structures are part of the microelectronic module. According to one alternative embodiment, the passive structures are a separate component of the flow-influencing element.

According to one preferred embodiment, the orientation, a time-dependent and/or a voltage amplitude-dependent control of the plurality of active flow-influencing elements and/or the orientation of the passive flow-influencing elements determine/determines the direction of the influence on the fluid. The direction of the influence on the fluid can be controlled by the orientation, a time-dependent and/or a voltage amplitude-dependent control of the plurality of flow-influencing elements. This has the advantage that the direction and/or speed of a fluid can be specifically influenced.

According to one preferred embodiment of the module comprising a plurality of flow-influencing elements, the module can comprise one or multiple switching elements which are designed or configured for activating and/or deactivating one or multiple flow-influencing elements of the plurality of flow-influencing elements. This has the advantage that the module can be individually controlled and the geometric dimensions can be kept small, depending on the application.

According to one preferred embodiment, the module comprises at least one receiver. The receiver is designed or configured for receiving a signal, wherein the switching element can be switched depending on the signal. For example, a signal can be transferred to the module from a central control unit which comprises at least one transmitter. The signal can be used, for example, for activating or deactivating the module. Alternatively, the signal can also have a more complex structure, for example in order to partially activate and/or deactivate a plurality of flow-influencing elements on a module or a plurality of modules. Alternatively, the voltage and/or amplitude of one or more flow-influencing elements can also be controlled with the aid of a signal. This has the advantage that the module can be individually controlled.

According to one preferred embodiment, the module comprises at least one transmitter. The transmitter is designed or configured for transmitting a signal to a receiver, wherein the signal includes at least information regarding the parameters detected by the module. The signal includes, for example, information regarding pressure, temperature and/or humidity which act on the module via the fluid. On the basis of the transmitted parameters, the control element can determine, for example, whether and how the hydrodynamic acceleration of the passing flow of fluid can be adjusted. This has the advantage that the module can be individually controlled.

According to a further embodiment, the module comprises at least one receiver and at least one transmitter. The receiver and the transmitter preferably have the same properties as the previously described receiver and transmitter.

According to one preferred embodiment, the module comprises at least one sensor. The sensor is designed or configured for gathering information regarding the module, information regarding the fluid and/or information regarding the environment of the module. The sensor can comprise, for example, multiple sub-sensors which are suitable for gathering information regarding the module, information regarding the fluid and/or information regarding the environment of the module. This has the advantage that the module can specifically influence the direction and/or speed of the fluid on the basis of the information regarding the module, information regarding the fluid and/or information regarding the environment of the module.

According to a further embodiment, the sensor is a pressure sensor, a temperature sensor and/or a humidity sensor.

The pressure sensor determines the pressure of the fluid flowing past. This has the advantage that the module receives information regarding the pressure of the passing flow of fluid on the sensor and can specifically influence the direction and/or speed of the fluid. Depending on the determined pressure, the module can adjust the voltage for generating the ionic current, if necessary.

The temperature sensor determines the temperature of the fluid flowing past the module. This has the advantage that the module receives information regarding the temperature of the fluid flowing past the sensor. Depending on the determined temperature, the module can adjust the voltage for generating the ionic current, if necessary.

The humidity sensor determines the humidity of the fluid flowing past the module. This has the advantage that the module receives information regarding the humidity of the fluid flowing past the sensor. Depending on the determined humidity, the module can adjust the voltage for generating the ionic current, if necessary.

According to one preferred embodiment, the determination of a pressure, a temperature and/or a humidity acting on the module due to the fluid flowing past is carried out by the flow-influencing element and/or a separate sensor. There is no need for another sensor for determining the pressure, temperature and/or humidity acting on the module, and so the geometric dimensions of the module can be kept very small. Alternatively, the detection of one or multiple parameters can be carried out, additionally or alternatively, by a separate sensor.

According to a preferred embodiment, the module comprises an acceleration sensor and/or a position sensor. With the aid of the acceleration sensor, the module can be activated, for example, when a predetermined minimum acceleration is detected. When a negative acceleration is present, the module can be, for example, deactivated or vice versa. With the aid of the position sensor, the position of the module can be determined, for example, wherein the module can be activated or deactivated in certain orientations. The acceleration sensor and/or the position sensor can be designed using MEMS technology, for example.

According to one preferred embodiment, the module comprises one control element. The control element is designed or configured for adjusting the hydrodynamic acceleration of the passing flow of fluid depending on the gathered information. The control element receives the information, which has been gathered by a sensor on the module, for example, and controls the active flow-influencing element and/or the plurality of active flow-influencing elements in such a way that the acceleration of the passing flow of fluid is adjusted or changed. This has the advantage that the module can be individually controlled.

According to one preferred embodiment, the module also comprises at least one switching element for activating and/or deactivating the module. Alternatively, a switching element can also be designed or configured for two or more modules. Therefore, two or more modules can be activated and/or deactivated via the switching element. This has the advantage that the module can be specifically activated or deactivated and, therefore, individually controlled.

The term “switching element” can be considered to be any type of device which is suitable for changing a connection from a disconnected state to a connected state. This can also be considered to be a connection which is open on one side and which can be permanently or reversibly closed, for example, by connecting the module to, for example, an electronic unit for control purposes.

According to one preferred embodiment, the voltage converter, the switching element, the flow-influencing element, the sensor, the receiver, the transmitter and/or the control element can be designed as a MEMS (microelectromechanical system) structure. By designing preferably a majority of the components of the module as a MEMS structure, the geometric dimensions of the module can be kept very small.

A module array comprising a plurality of previously described microelectronic modules is also provided. By arranging a plurality of the modules in an array, the hydrodynamic effect can be amplified and/or utilized in a specifically oriented manner.

According to one embodiment, multiple microelectronic modules can also be disposed on a shared, thin-film, planar substrate.

According to one preferred embodiment, the active and/or passive flow-influencing elements of the plurality of microelectronic modules have, at least partially, a different orientation. Due to an at least partially different orientation of the modules and, therefore, of the active and/or passive flow-influencing elements of the modules, the direction and/or the speed of a fluid flowing around and/or over the arrangement can be specifically influenced by the hydrodynamic effect.

The effect of the active flow-influencing elements can be supported or amplified by passive flow-influencing elements, more specifically, passive structures. These passive structures can be 3D, microtechnical, passive and/or resonant structures which can locally influence, preferably swirl, channel, or locally deflect, the generated flow.

According to one preferred embodiment, the module array comprises one or more switching elements, which are designed or configured for activating and/or deactivating one or more flow-influencing elements of the module array. This has the advantage that the module array can be individually controlled and the geometric dimensions can be kept small, depending on the application.

In addition, an arrangement of at least one previously described microelectronic module or at least one previously described module array on a surface of a vehicle is provided. Due to the use of at least one module or at least one module array, it is possible to specifically influence the direction and/or speed, for example, of effects in the region of the boundary layer which occur due to the flow around or over a surface of a vehicle.

According to one preferred embodiment, the vehicle is an aircraft, a watercraft, or a ground vehicle. Due to the arrangement of at least one module or at least one module array, the direction and/or speed of fluids can be positively influenced, and so, for example, a flow resistance can be reduced and, as a result, fuel or energy used for driving the vehicle can be saved.

In addition, a method for influencing a flow of a fluid using at least one previously described microelectronic module or at least one module array can be provided. In the method, the direction and/or speed of the flow of a fluid flowing around and/or over a surface of the module or module array is influenced. In the method, a provided first voltage is converted into a higher, lower, or identical second voltage. In the method, in addition, a hydrodynamic acceleration is generated as a function of the second voltage. In the method, in addition, the direction and/or the speed of the fluid are is influenced by the hydrodynamic acceleration.

### BRIEF DESCRIPTION OF THE DRAWINGS

In the drawings, reference numbers that are generally the same refer to the same parts in all the different views. The drawings are not necessarily to scale; instead, value is placed, in general, on the explanation of the principles of the disclosure herein. In the following description, different embodiments of the disclosure herein are described with reference to the following drawings, in which:

FIG. 1 shows a first embodiment of a microelectronic module;

FIG. 2 shows a module array comprising a plurality of microelectronic modules;

FIG. 3 shows the arrangement of a plurality of microelectronic modules on the surface of an aircraft; and

FIG. 4 shows a flow chart of a method for influencing a flow of a fluid.

### DETAILED DESCRIPTION

The following detailed description refers to the attached drawings which, for the purpose of explanation, show specific details and embodiments in which the disclosure herein can be put into practice.

The expression “exemplary” is used in this case to mean “serving as an example, a case, or an illustration”. Every embodiment or configuration described herein as “exemplary” should not necessarily be interpreted to be preferred or advantageous over other embodiments or configurations.

In the following extensive description, reference is made to the attached drawings which form a part of this description and in which, for purposes of illustration, specific embodiments in which the disclosure herein can be applied are shown. In this regard, directional terminology is used, such as, for example, “top”, “bottom”, “front”, “back”, “leading”, “trailing”, etc., with reference to the orientation of the described figure or figures. Since components of embodiments can be positioned in a number of different orientations, the directional terminology is used for purposes of illustration and is in no way limiting. It is clear that other embodiments can be used and structural or logical changes can be made without deviating from the scope of protection of the subject matter disclosed herein. It is clear that the features of the different exemplary embodiments described herein can be combined with one another, unless specifically indicated otherwise elsewhere. The following extensive description should therefore not be interpreted to be limiting, and the scope of protection of the subject matter disclosed herein is defined by the attached claims.

Within the scope of this description, the terms “connected” and “coupled” are used for describing both a direct as well as an indirect connection and a direct or an indirect coupling. In the figures, identical or similar elements are provided with identical reference numbers, to the extent this is appropriate.

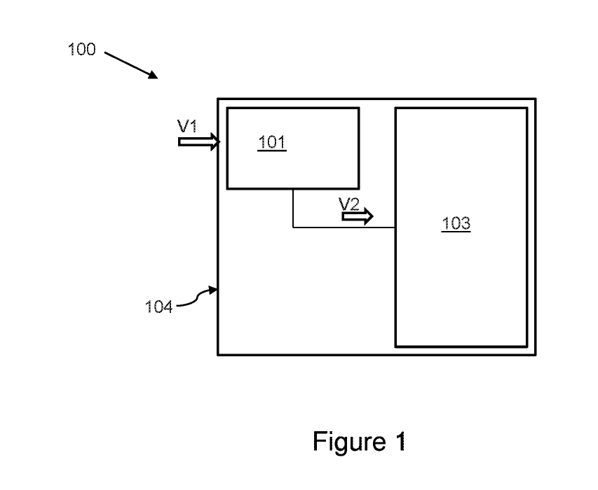

FIG. 1 shows a first embodiment of a microelectronic module 100 for influencing a flow of a fluid. The module 100 comprises a voltage converter 101 for converting a provided first voltage V1 into a higher, lower, or identical second voltage V2. The module 100 also comprises an active flow-influencing element 103 for influencing the direction and/or the speed of a fluid flowing around and/or over the active flow-influencing element 103. The voltage converter 101 and the active flow-influencing element 103 of the module 100 are disposed on a thin-film, planar substrate 104. The voltage converter 101 and the flow-influencing element 103 of the module 100 are electrically coupled to one another. The influencing of the direction and/or the speed of the fluid is dependent on a hydrodynamic acceleration as a function of the second voltage V2 provided by the voltage converter 101 to the flow-influencing element 103. In addition to the active flow-influencing element 103, another passive flow-influencing element (not illustrated), for example, a passive, three-dimensional structure, can be provided on the module 100. The module can comprise a switching element (not illustrated) for the purpose of specifically activating and/or deactivating the flow-influencing element 103.

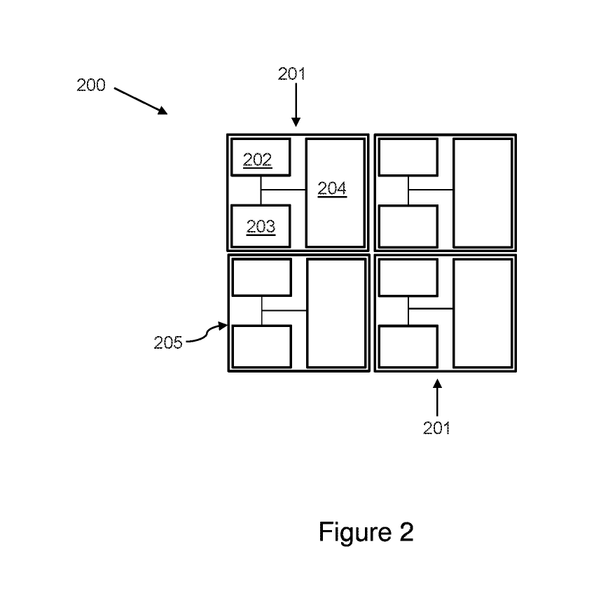

FIG. 2 shows one embodiment of a module array 200 comprising a plurality of microelectronic modules 201. Each of the microelectronic modules 201 comprises a voltage converter 202, a switching element 203, and a flow-influencing element 204 on a thin-film, planar substrate 205. Although each of the depicted modules 201 comprises a separate switching element 204, according to an alternative embodiment (not illustrated), a switching element 204 can also be provided for two or more modules 201.

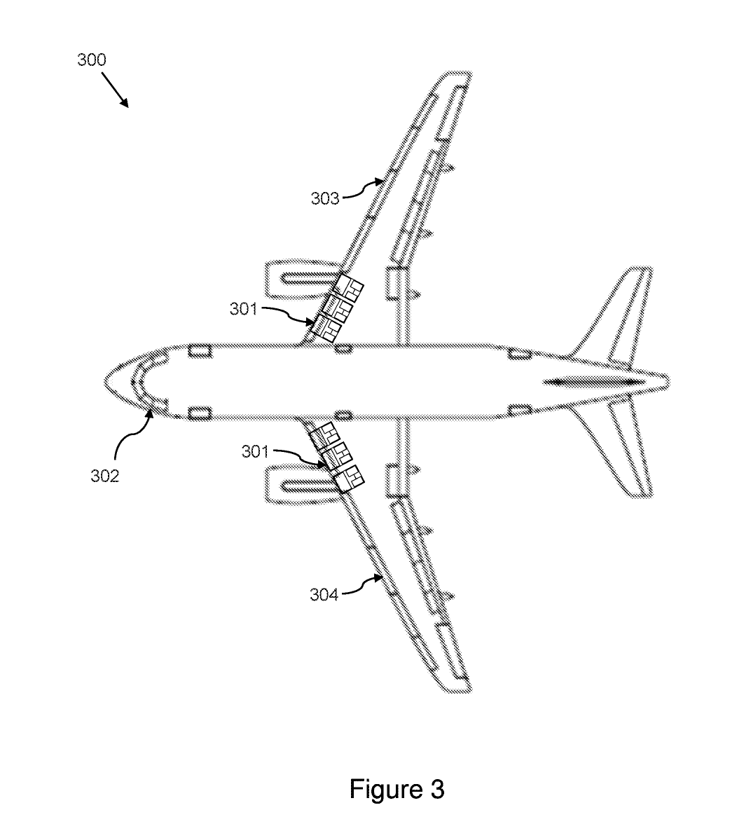

FIG. 3 shows one embodiment of an arrangement 300 of a plurality of microelectronic modules 301 on the surface of an aircraft 302. In the embodiment shown, multiple microelectronic modules 301 are arranged on the wings 303, 304 of the aircraft 302 in the region of the leading edge of the wing in order to reduce friction losses at the leading edge of the wing.

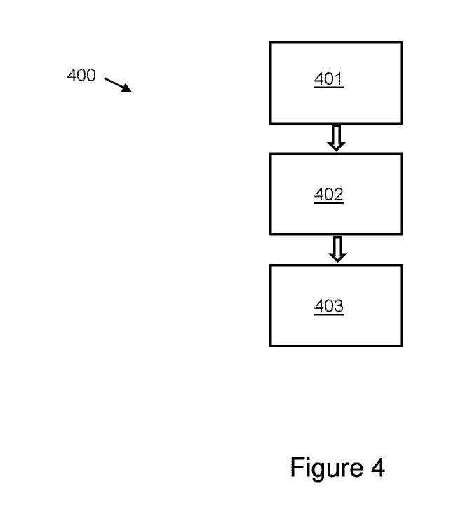

FIG. 4 shows a flow chart 400 of one embodiment of a method for influencing a flow of a fluid using at least one microelectronic module or at least one module array. In step 401, a first voltage is provided, which is converted into a second voltage which is higher than, lower than, or equal to the first voltage. With the aid of the second voltage, a hydrodynamic acceleration is generated in step 402 as a function of the second voltage. In step 403, the direction and/or the speed of the fluid are is influenced by the generated hydrodynamic acceleration.

Although the disclosure herein has been shown and described primarily with reference to certain embodiments, persons who are familiar with the technical field should understand that numerous modifications with respect to the embodiment and details can be made thereto without deviating from the nature and scope of the disclosure herein as defined by the attached claims. The scope of the disclosure herein is therefore determined by the attached claims, and it is therefore intended that all changes that fall within the literal scope or the doctrine of equivalents of the claims be included.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

LIST OF REFERENCE NUMBERS

| | |
|---|---|
| 100, 201, 301 | Module |
| 101, 202 | Voltage converter |
| 103, 204 | Active flow-influencing element |
| 104, 205 | Substrate |
| 200 | Module array |
| 203 | Switching element |
| 300 | Arrangement |
| 302 | Aircraft |
| 303, 304 | Wing |
| 400 | Flow chart |
| 401-403 | Method steps |
| V1 | First voltage |
| V2 | Second voltage |

1. A microelectronic module for influencing a flow of a fluid, comprising:
at least one voltage converter for converting a provided first voltage into a higher, lower, or identical second voltage;
at least one active flow-influencing element for influencing a direction and/or speed of a fluid which is flowing around and/or over the active flow-influencing element;
wherein at least the voltage converter and the active flow-influencing element are disposed on a thin-film, planar substrate; and
wherein the influencing of the direction and/or the speed of the fluid is dependent on a hydrodynamic acceleration as a function of the second voltage provided by the voltage converter at the active flow-influencing element.

2. The microelectronic module as claimed in claim 1, wherein the voltage converter comprises a piezoelectric transformer.

3. The microelectronic module as claimed in claim 1, wherein the provided first voltage for the voltage converter is provided, at least partially, via an external voltage source.

4. The microelectronic module as claimed in claim 1, wherein the substrate further comprises an energy-generating element for generating at least a portion of the first voltage to be provided, or
wherein the substrate further comprises an energy-generating element for generating at least a portion of the first voltage to be provided, wherein the energy-generating element comprises a solar cell arrangement.

5. The microelectronic module as claimed in claim 1, wherein the thin-film, planar substrate is a flexible and/or multidimensionally deformable film or lattice.

6. The microelectronic module as claimed in claim 1, wherein the module comprises a plurality of active flow-influencing elements, wherein the active flow-influencing elements have a different orientation and/or an identical orientation; or
wherein the module comprises a plurality of active flow-influencing elements and at least one passive flow-influencing element, wherein the active and/or passive flow-influencing elements have a different orientation and/or an identical orientation.

7. The microelectronic module as claimed in claim 6, wherein the orientation, a time-dependent and/or a voltage amplitude-dependent control of the plurality of active flow-influencing elements and/or the orientation of the passive flow-influencing elements determine/determines the direction of the influence on the fluid.

8. The microelectronic module as claimed in claim 1, wherein the module comprises at least one receiver configured for receiving a signal, wherein the switching element can be switched depending on the signal; and/or
wherein the module comprises at least one transmitter configured for transmitting a signal to a receiver, wherein the signal includes at least information regarding the parameters detected by the module.

9. The microelectronic module as claimed in claim 1, wherein the module comprises at least one sensor configured for gathering information regarding the module, information regarding the fluid and/or information regarding the environment of the module, wherein the sensor is a pressure sensor, a temperature sensor and/or a humidity sensor.

10. The microelectronic module as claimed in claim 1, wherein the determination of a pressure, a temperature and/or a humidity acting on the module due to the fluid flowing past is carried out by the flow-influencing element and/or a separate sensor.

11. The microelectronic module as claimed in claim 1, wherein the module comprises a control element configured for adjusting the hydrodynamic acceleration of a passing flow of fluid depending on gathered information; and/or
wherein the module comprises at least one switching element for activating and/or deactivating the module.

12. The microelectronic module as claimed in claim 1, wherein the voltage converter, the switching element, the flow-influencing element, the sensor, the receiver, the transmitter and/or the control element are designed as a MEMS structure.

13. A module array comprising a plurality of microelectronic modules as claimed in claim 1, wherein the active and/or passive flow-influencing elements of the plurality of microelectronic modules have, at least partially, a different orientation.

14. An arrangement at least of a microelectronic module or at least a module array as claimed in claim 1 on a surface of a vehicle,
wherein the vehicle is an aircraft, a watercraft, or a ground vehicle.

15. A method for influencing a flow of a fluid using at least one microelectronic module or at least one module array as claimed in claim 1, wherein the direction and/or speed of the flow of a fluid flowing around and/or over a surface of the module or module array is influenced, the method comprising:
converting a provided first voltage into a higher, lower, or identical second voltage;
generating a hydrodynamic acceleration as a function of the second voltage; and
influencing the direction and/or the speed of the fluid by the hydrodynamic acceleration.
